(19) United States
(12) Patent Application Publication
(10) Pub. No.: US 2016/0037290 A1
(43) Pub. Date: Feb. 4, 2016

(54) Method of Electronic Device Identification and Localization Based on Active Code Transmission

(71) Applicant: Daniel Frederick Heywood, Reno, NV (US)

(72) Inventor: Daniel Frederick Heywood, Reno, NV (US)

(21) Appl. No.: 14/446,125

(22) Filed: Jul. 29, 2014

(51) Int. Cl. H04W 4/02; H04B 10/116; H04B 10/079

(52) U.S. Cl. CPC H04W 4/02; H04B 10/07955; H04B 10/116

(57) ABSTRACT

A method for uniquely identifying and locating one or more electronic devices by means of a data-bearing signal transmission is disclosed. The method is specifically configured to locate a large number of similar electronic devices. In one embodiment, a receiving side system assigns a unique digital identity to an electronic device by means of a data transmission network. The electronic device subsequently processes this unique digital identity and constructs a waveform to encode the identity in a manner that can be transmitted. The waveform is converted to a propagating signal by means of an optical transmitter. The signal is received by an optical receiver and converted to an electrical signal that is subsequently processed to determine the unique identity encoded. Methods of encoding the identity in the frequency domain representation of the waveform, and identifying device location by means of a sensor array, are disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to the field of unique electronic device identification and localization techniques. More particularly, the present invention relates to methods of uniquely identifying and locating one or more electronic devices by means of data digitally encoded in a signal transmitted by the device and received by one or more sensors.

2. Description of Related Art

Currently there exist many techniques and protocols by which an electronic device can communicate a piece of unique identifying information to another electronic device. One example of such a technique is RFID (radio-frequency identification), wherein data, often simply an identifier, is communicated by means of an electromagnetic transmission in the radio spectrum. RFID is commonly used in access control, asset tracking, and other applications where automatic identification of a device is required. Due to its limited range, merely a few inches in some instances, RFID applications often involve some degree of spatial localization. The limited range, along with directional antennas can be used to determine that an identified device occupies a particular space. However, the relatively long wavelength of the radio spectrum used limits the directionality of the signal, which prohibits precise localization from long distances. Thus, there exists a need for a method of device identification at long distances that preserves the ability to precisely identify not only the device, but also its physical location. In addition, RFID techniques often require dedicated hardware, with no secondary application. Thus, there also exists a need for a method of identifying an electronic device without requiring the addition of new hardware.

### BRIEF SUMMARY OF THE INVENTION

In a preferred embodiment, the present invention comprises a method of determining the unique identity and physical location of an electronic device. A digital representation of the unique identity of the electronic device is stored in a device memory. From this digital representation, a time varying waveform is constructed by a processor of the electronic device. This waveform encodes the digital information. The encoding may be in the time domain or frequency domain depending on the application and noise spectrum. A time domain encoding is comprised of a time sequence of discrete bits representing the digital representation of the unique identity, where each bit state corresponds to a waveform signal amplitude range. Alternatively, a frequency domain encoding is comprised of a sum of discrete periodic waveforms representing the digital representation of the unique identity, where each digital bit, corresponding to a defined waveform frequency, has a state given by the relevant waveform amplitude.

The waveform is then represented as a propagating signal. In a preferred embodiment, this signal is an optical signal produced by a light emitting element of the electronic device. The propagating signal is then received and converted to a time varying electrical signal by one or more elements of a sensor array. In a preferred embodiment, this sensor array is an optical camera. The time varying electrical signal is then processed by a processor to decode the digital representation of the unique identity. This decoding can be accomplished for a time domain encoded signal by bit checking as time progresses. Techniques for recovering time domain encoded digital signals are well known to those skilled in the art. For a frequency domain encoded signal, the digital representation of the unique identity can be recovered by transforming the time varying electrical signal from the sensor array elements to the frequency domain. Techniques for transforming a time varying signal to the frequency domain are well known to those skilled in the art, and include the many fast Fourier transform algorithms.

Specific applications may benefit from additional features. For example, the electronic device may not have a universally unique identity, and the device must simply be differentiated from other devices in close proximity for the purpose of determining its location. In such a case, the receiver may communicate with a processor, said processor communicating with the electronic device processor by means of a network connection. The receiving side processor can then assign an identity to each electronic device, by which it can differentiate between all those seen by the sensor array, and determine the location of each. Furthermore, the receiving side processor may employ algorithms to track the motion of each device in time. Such algorithms for optical tracking are well known to those skilled in the art. Tracking would allow successful signal reception and decoding even if the received signal moves between different elements of the sensor array.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below. In this respect, before explaining at least one preferred embodiment of the invention in detail, it is to be understood that the invention is not limited in its application to the details of the implementation set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWINGS

FIG. 1 is a diagram illustrating the general physical layout of one embodiment of the present invention.

FIG. 2 is a network diagram illustrating the connections among various features of one embodiment of the present invention.

FIG. 3 is a network diagram illustrating the connections among various features of one embodiment of the present invention.

FIG. 4 is a flowchart depicting various steps in the transmission of a unique identifier.

FIG. 5 is a graphical depiction, in the time domain, of an example signal waveform for a time domain data encoding scheme.

FIG. 6 is a graphical depiction, in the frequency domain, of a frequency domain data encoding scheme.

FIG. 7 is a plot of an actual frequency domain encoded signal with noise and signal degradation present.

FIG. 8 is a simple graphical depiction of a signal sensor array.

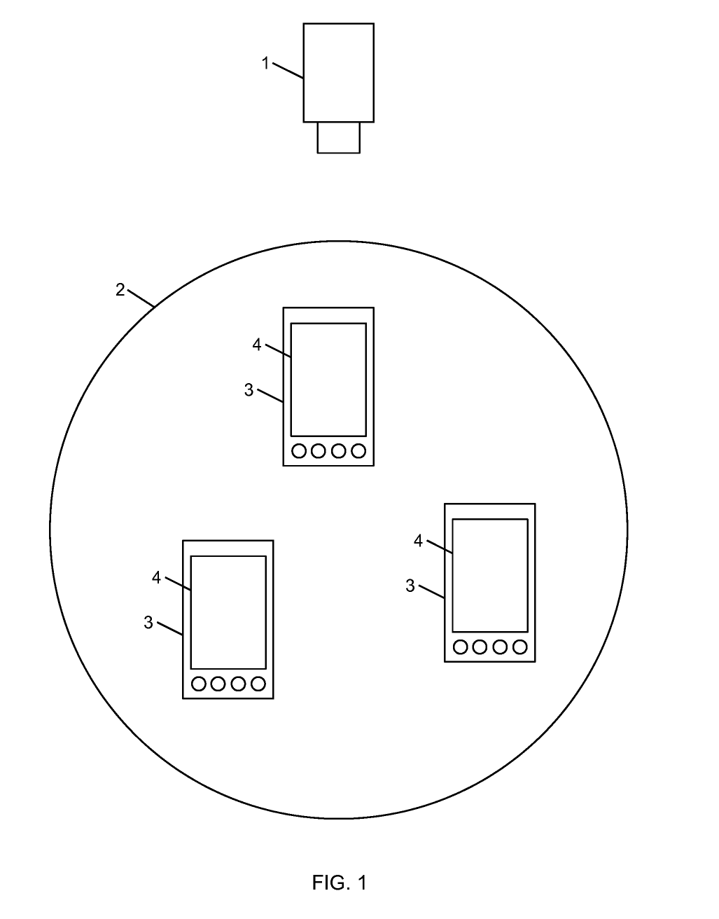

### DETAILED DESCRIPTION OF THE INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized without departing from the scope of the present invention.

The present invention, according to the preferred embodiment, comprises a method of uniquely identifying and locating one or more electronic devices 3, which may be in close physical proximity such that they form a crowd 2, by means of one or more signal receiving and processing systems 1. The electronic devices 3 may be smartphones, smart watches, tablet computers, application specific hardware, or any other devices with a means of generating and transmitting a propagating signal. The electronic device 3 would include at least a memory 5, a processor 6, and an optical transmitter 7. Alternatively, the optical transmitter may be replaced with a signal transmitter 12 operating at a different frequency. In one preferred embodiment, the optical transmitter 7 may be a general purpose display screen 4 of the electronic device 3. The signal receiving and processing system 1 would include at least an optical receiver 8, a processor 9, and a memory 10. Alternatively, the optical receiver may be replaced with a signal receiver 13 operating at a different frequency. In one preferred embodiment, the optical receiver 8 may be a general optical video camera.

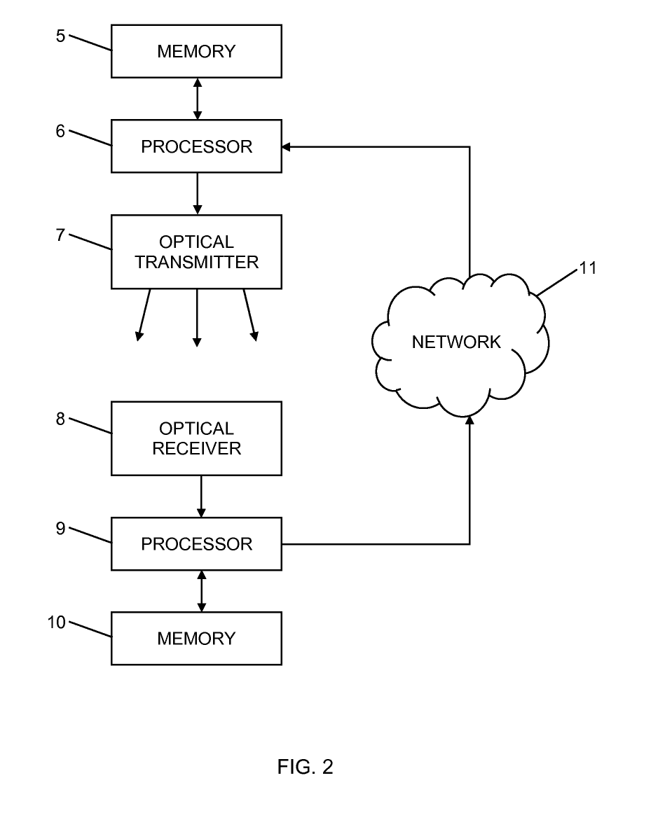

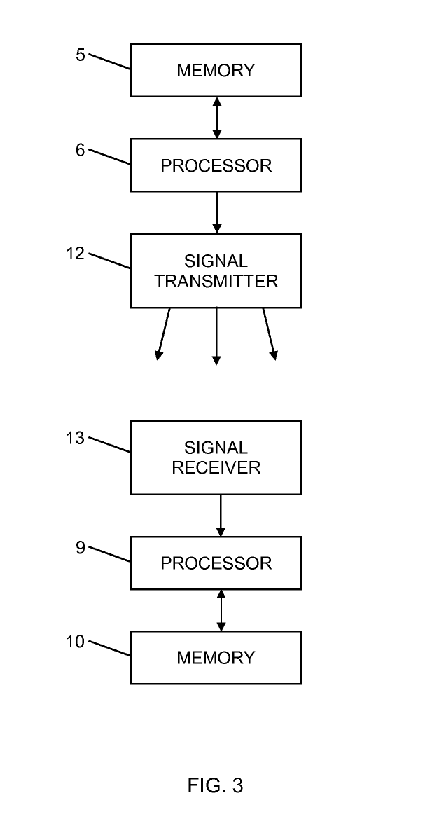

FIG. 2 further shows that the signal receiving and processing system 1 processor 9 may communicate with the electronic device 3 processor 6 by means of a network 11. In such a case, the signal receiving and processing system 1 may assign a unique identity 14 to the electronic device. A digital representation 15 of this unique identity 14 may be stored in the memory 5. The network 11 may be any form of digital communication network, such as a wireless local area network or cellular data network. Alternatively, as shown in FIG. 3, the electronic device 3, comprised of a memory 5, processor 6, and signal transmitter 12, and the signal receiving and processing system 1, comprised of a signal receiver 13, processor 9, and memory 10, may operate independently. In such a case, a digital representation 15 of the unique identity 14 is stored permanently in the electronic device 3 memory 5.

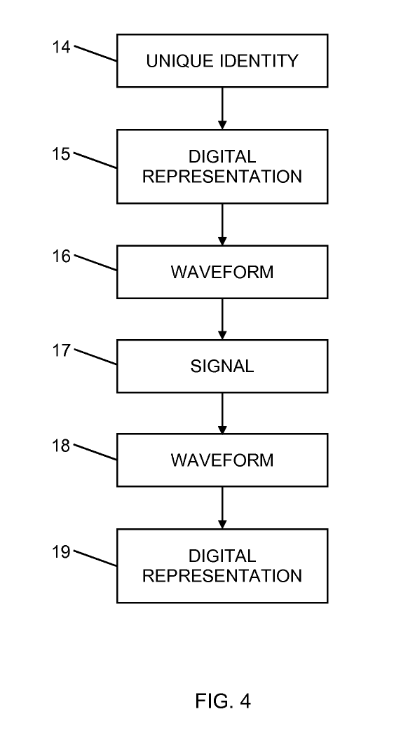

FIG. 4 illustrates a general method of representing and transmitting a unique identity 14. The unique identity 14 is converted to a digital representation 15. This digital representation 15 can be stored in a memory 5, or directly processed. The digital representation 15 is then processed, by a processor 6, to create a waveform 16 representing the unique identity 14 by means of some signal encoding technique. This waveform 16 is then converted to a propagating signal 17 by an optical transmitter 7, or other signal transmitter 12. The propagating signal is then received and converted to a waveform 18 by an optical receiver 8, or other signal receiver 13. This waveform 18 can then be processed, by a processor 9, to recover a digital representation 19 of the unique identity 14.

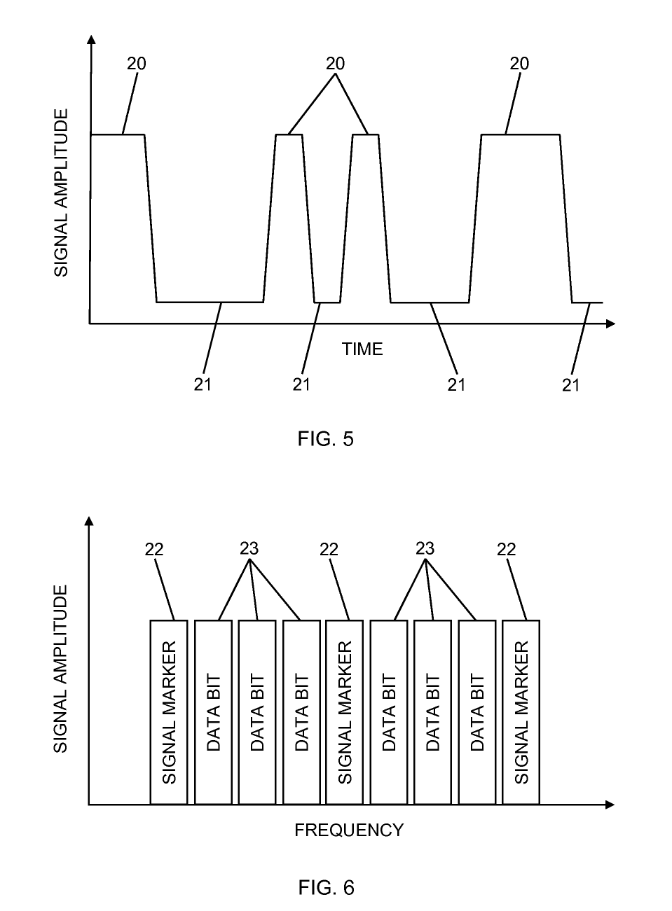

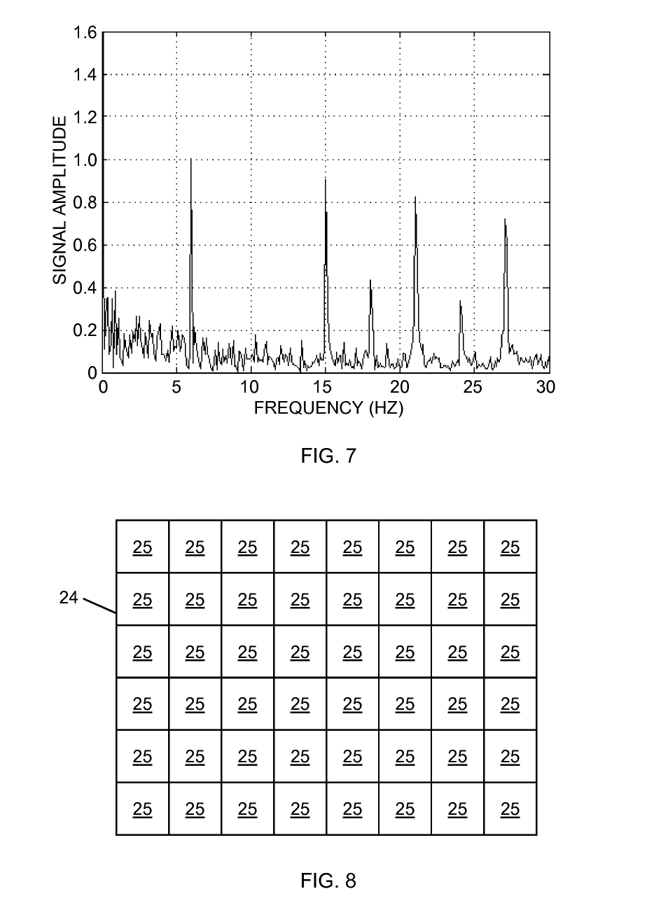

Several approaches can be used to encode the digital representation 15 of the unique identity 14 in the waveform 16. One approach is illustrated in FIG. 5, wherein the digital representation 15 is encoded as signal amplitude variations in the time domain. Such an encoding, which is well known to those skilled in the art, is comprised of a time series of logic high 20 or logic low 21 signals. An alternative approach, which has considerable advantages in certain high-noise environments, is illustrated in FIG. 6, wherein the digital representation 15 is encoded as a series of data bits 23 located at different frequencies in the frequency domain representation of the waveform 16. A data bit 23 can simply be comprised of a peak in the signal at a specific frequency. The presence, absence, or height of a peak in the frequency domain can be used to encode the state of a data bit 23. The frequency at which the peak is located is used to determine the position of the data bit 23 in the digital representation 15. Given that the information is digital, both the peak heights and peak positions are discretized. An example signal, encoding a particular digital representation 15, with noise and signal degradation, is shown in FIG. 7.

It can be seen in FIG. 7 that many false peaks are present due to noise. Several methods can be employed to ensure that these peaks are not mistaken for valid data. One such method is to use a set of signal markers 22 in the frequency domain. These signal markers 22 may be signal peaks at specific frequencies. The electronic device 3 processor 6 would encode these peaks in the waveform 16 apart from the digital representation 15 of the unique identity 14. The signal receiving and processing system 1 processor 9 would then search for the signal markers 22, or the correct pattern of signal markers 22. If more than one signal marker 22 is employed, as is shown in FIG. 6, the ratio of the heights of the different signal marker 22 peaks may further be used as a signal identifier. For example, if the signal markers 22 can take on three different discrete states, one signal marker 22 may be in a first state, another signal marker 22 may be in a second state, and another signal marker 22 may be in a third state, to identify a valid data-bearing signal 17. Furthermore, the height of each signal marker 22 may be used as a reference value by which the state of each data bit 23 may be determined. Thus, the one or more signal markers serve to confirm that a data-bearing signal 17 is present, and allow accurate state determination of the data bits 23.

There exist many specific methods of constructing the waveform 16 to be transmitted, and subsequently interpreting the waveform 18 received. Methods of so doing for a time domain encoding are well known to those skilled in the art. For a frequency domain encoding many approaches, of varying rigor, can be employed. One preferred method has the electronic device 3 processor 6 sum a series of periodic functions of time of varying frequencies, wherein a specific frequency corresponds to a particular data bit 23 position in the digital representation 15 of the unique identity 14. The magnitude of each periodic function would be dictated by the state of the corresponding data bit 23. The periodic functions could be sinusoids, or other periodic functions. By summing the various time varying functions, a waveform 16 would be constructed by the processor 6 with sharp and specific features in the frequency domain. The phase of each periodic function may be equal, or phase offsets may be introduced to encode additional information.

The interpretation of the received waveform 18 may be carried out in many ways. Methods of so doing for a time domain encoding are well known to those skilled in the art. For a frequency domain encoding, the signal receiving and processing system 1 processor 9 may run one of the many fast Fourier transform algorithms on the received waveform 18 to generate a frequency domain representation of the waveform 18. This frequency domain representation of the waveform 18 may include both signal amplitude and signal phase components. Once the waveform 18 is transformed to the frequency domain, the processor 9 may run a peak finding algorithm to identify peaks. Such algorithms are well known to those skilled in the art. The list of signal peaks in the frequency domain can then be searched to identify peaks that fall within the domain of each data bit 23 and signal marker 22. In order to combat the effects of noise in the received signal 17, a signal scoring technique may be employed. Such a technique may generate a signal clarity score based on the distance of the identified signal peaks to the nominal frequency locations of each data bit 23, and the height of the data bit 23 signal peaks relative to those identified as signal marker 22 peaks. This approach maintains the discrete nature of the digital representation 15, but allows for a quantitative assessment of signal quality and confidence. A minimum signal quality threshold, based on the above approach, can be set to prevent the use of a digital representation 19 derived from a low quality waveform 18.

One primary feature of the present invention is the ability to determine, in some sense, the physical location of one or more electronic devices 3 that have been uniquely identified. This can be accomplished by determining, at any giving moment in time, which element 25 of a sensor array 24 is receiving the signal of the identified electronic device 3. The sensor array 24 would be constructed in such a way that each element 25 receives information, whether visible light or another form of signal, incident at a particular angle, or range of angles, relative to a reference. One example of such a device is an optical video camera. The signal receiving and processing system 1 would include at least one optical receiver 8. This optical receiver 8 may be a sensor array 24. If only one sensor array 24 is used in the signal receiving and processing system 1, the system 1 may locate specific electronic devices 3 by making certain assumptions about their position, such as assuming that they occupy a plane or generic surface. Such an assumption may be quite good when the crowd 2 occupies a field or stadium at a large festival or concert. The location of each electronic device 3 could be found as the intersection of the plane or surface and the line defined by the angle of incidence to the sensor array 24.

The present invention may be used in numerous applications, and numerous challenges may arise for each specific application. One application of special interest is the determination of the physical location of electronic devices 3 possessed by members of a large, physically dense crowd 2. Such an application may arise, for example, from efforts to map graphical content to a crowd 2 at a concert or other event. In such an application there is the possibility that an electronic device 3 may be observed by different elements 25 of the sensor array 24 over the course of the identification process, as the audience member moves about the crowd 2. In order to recover the correct digital representation 19, the full signal 17 to be processed into the waveform 18 may be constructed from pieces of the signal 17 captured by different sensor elements 25 and stitched together in time by the processor 9. This may be facilitated by an object tracking algorithm, many examples of which are well known to those skilled in the art, run by the processor 9 on the data received from the sensor array 24. Such an algorithm would allow the processor 9 to identify which sensor element 25 returns the waveform 18 for a given electronic device 3 at any given time.

Furthermore, the present invention allows for the determination, and correction, of temporal errors between the electronic devices 3 and the signal receiving and processing system 1. Such errors may come about as latency in the network 11 when communication occurs in real time, or as clock offsets when delay is intended. Various methods may be used to measure the temporal errors, depending on the data encoding method. If the digital representation 15 is encoded in the waveform 16 as a frequency domain representation, as previously disclosed, the phase of the signal frequency components may be used to determine the time offset. The signal receiving and processing system 1 processor 9 would process the waveform 18 to produce both the amplitude and phase components of the signal 17 in the frequency domain. By observing the phase across a range of frequencies, the system receiving and processing system 1 can determine the temporal error both with a large range and a high precision. The electronic device 3 processor 6 could introduce a low frequency component to the waveform 17. By observing the phase of this component, the signal receiving and processing system 1 could determine large temporal errors, perhaps on the order of several seconds. In addition, by observing the phase of the high frequency components of the signal 17, the signal receiving and processing system 1 could determine the temporal error with high precision, perhaps on the order of a few tens of milliseconds.

I claim:

1. A method of determining the unique identity and physical location of an electronic device, comprising:
a. storing a digital representation of the unique identity in a device memory;
b. transmitting the digital representation of the unique identity through space by controlling the variation in time of the intensity of a light emitting element of the electronic device;
c. measuring, by one or more elements of a sensor system, the variation in time of the intensity of the light emitting element of the electronic device and representing the measured variation as an electrical signal;
d. processing the electrical signal to produce a digital representation of the unique identity;
e. determining the physical location of the identified device by assessing which element or elements of the sensor system produced the electrical signal.

2. The method of claim 1, wherein the variation in time of the intensity of the light emitting element of the electronic device encodes the digital representation of the unique identity as a time sequence of one or more discrete information bits, wherein a bit state corresponds to a defined optical display element intensity range.

3. The method of claim 1, wherein the variation in time of the intensity of the light emitting element of the electronic device encodes the digital representation of the unique identity as a sum of one or more periodic waveforms of different frequencies, wherein the digital representation is represented as a series of discrete information bits, each bit corresponding to a particular waveform frequency range, with a bit state corresponding to the waveform amplitude range.

4. The method of claim 3, wherein the variation in time of the intensity of the light emitting element of the electronic device includes at least one periodic waveform of a defined frequency and amplitude apart from the digital representation.

5. The method of claim 4, wherein the periodic waveform of a defined frequency and amplitude is used as a signal reference value to determine the state of each information bit in the digital representation.

6. The method of claim 3, wherein the information quality of the variation in time of the intensity of the light emitting element is assessed by comparing the sensed waveform frequencies to a set of nominal encoding standard frequencies.

7. The method of claim 3, wherein the information quality of the variation in time of the intensity of the light emitting element is assessed by comparing the sensed waveform amplitudes to a set of nominal encoding standard amplitudes.

8. The method of claim 1, wherein the sensor system is an optical video camera.

9. The method of claim 1, wherein the unique identity of the electronic device is assigned, by means of a data network, by a processor connected to the sensor system.

10. A method of determining the unique identity of an electronic device, comprising:
a. storing a digital representation of the unique identity in a device memory;
b. transmitting the digital representation of the unique identity through space as an electromagnetic wave, wherein the digital information is encoded as a sum of discrete periodic waveforms of different frequencies;
c. converting the electromagnetic wave to a time varying electrical signal by one or more sensors;
d. processing the time varying electrical signal to produce a digital representation of the unique identity.

11. The method of claim 10, wherein the electromagnetic wave includes at least one periodic waveform of a defined frequency and amplitude apart from the digital representation.

12. The method of claim 11, wherein the periodic waveform of a defined frequency and amplitude is used as a signal reference value to determine the state of each information bit in the digital representation.

13. The method of claim 10, wherein the information quality of the time varying electrical signal is assessed by comparing the sensed waveform frequencies to a set of nominal encoding standard frequencies.

14. The method of claim 10, wherein the information quality of the time varying electrical signal is assessed by comparing the sensed waveform amplitudes to a set of nominal encoding standard amplitudes.
